(19) United States
(12) Patent Application Publication
(10) Pub. No.: US 2008/0072325 A1
(43) Pub. Date: Mar. 20, 2008

(54) THREAT DETECTING PROXY SERVER

(76) Inventors: Rolf Repasi, Sunrise Beach (AU); Simon Clausen, New South Wales (AU)

Correspondence Address: BRINKS HOFER GILSON & LIONE, P.O. BOX 10395, CHICAGO, IL, 60610, US

(21) Appl. No.: 11/854,755

(22) Filed: Sep. 13, 2007

Related U.S. Application Data
(60) Provisional application No. 60/844,574, filed on Sep. 14, 2006.

(51) Int. Cl. G06F 11/00

(52) U.S. Cl. 726/23

(57) ABSTRACT

A method, system, computer program product and a computer readable medium of instructions for restricting a client processing system being compromised. The method comprises: receiving, in a proxy server, response data from a remote processing system, according to a request from the client processing system to download data from the remote processing system; analysing the response data to determine if at least a portion of the response data is malicious; and in the event that at least a portion of the response data is malicious, modifying the response data to restrict the client processing system being comprised.

This application claims the benefit of priority from U.S. Provisional Patent Application No. 60/844,574 filed Sep. 14, 2006, and is incorporated by referenced.

### TECHNICAL FIELD

The present invention generally relates to the field of computing, and more particularly to a method, system, computer readable medium of instructions and/or computer program product for detecting threats such as malicious software at a proxy server.

### COPYRIGHT

A portion of the disclosure of this patent document contains material that is subject to copyright protection. The copyright owner has no objection to the facsimile reproduction by anyone of the patent disclosure, as it appears in a Patent Office patent files or records, but otherwise reserves all copyrights whatsoever.

### BACKGROUND ART

As used herein a “threat” comprises malicious software, also known as “malware” or “pestware”, which comprises software that is included or inserted in a part of a processing system for a harmful purpose. The term threat should be read to comprise possible, potential and actual threats. Types of malware can comprise, but are not limited to, malicious libraries, viruses, worms, Trojans, adware, malicious active content and denial of service attacks. In the case of invasion of privacy for the purposes of fraud or theft of identity, malicious software that passively observes the use of a computer is known as “spyware”.

There are currently a number of techniques to restrict malicious software compromising a processing system.

One technique comprises using database driven malicious software techniques at a user's processing system to detect known malicious software. In this technique, a database is used which generally comprises a signature indicative of a particular type of malicious software. The signatures are then compared to the downloaded entity, such as an executable file, to determine if the entity is malicious.

However, this technique suffers from a number of disadvantages. This technique requires the user of the processing system to continually update the signatures from a vendor's server processing system. If updates are not regularly completed then new forms of malicious software may not be detected, thereby compromising the user's processing system.

Another technique used is code-signing. Code-signing attempts to assure users that downloaded software, such as an executable file downloaded from a web-site, has been supplied by a trusted software vendor that is participating in an infrastructure of trusted entities. Such a trusted infrastructure is available using Microsoft™ Authenticode. This mechanism generally involves the use of digital signatures and certificates in order to verify the software vendor.

However, code-signing also suffers from disadvantages. Firstly, code-signing does not analyse whether the downloaded software is malicious. It only guarantees that the software vendor is part of the trusted infrastructure. Additionally, it is still possible that an author of malicious software may join the infrastructure of trusted entities, if they meet particular criteria such as an acceptable Dun & Bradstreet Rating, prior to publishing malicious software for download by the public.

Therefore there is a need for a method, system, computer program product and/or computer readable medium of instructions which addresses or at least ameliorates one or more problems inherent in the prior art.

A proxy server is a server which is intermediate a client processing system and the network, such as the Internet. A proxy server may be a processing system, or a software application which executes on a processing system.

Hyper Text Transfer Protocol (HTTP) is a protocol used to request and transfer files, especially web-pages and web-page components, over the Internet or other computer networks.

File Transfer Protocol (FTP) is a communications protocol for the transfer of files over a computer network.

A hash function (i.e. Message Digest, eg. MD5) can be used for many purposes, for example to establish whether a file transmitted over a network has been tampered with or contains transmission errors. A hash function uses a mathematical rule which, when applied to a file, generates a hash value, i.e. a number, usually between 128 and 512 bits in length. This number is then transmitted with the file to a recipient who can reapply the mathematical rule to the file and compare the resulting number with the original number.

In a networked information or data communications system, a user has access to one or more terminals which are capable of requesting and/or receiving information or data from local or remote information sources. In such a communications system, a terminal may be a type of processing system, computer or computerised device, personal computer (PC), mobile, cellular or satellite telephone, mobile data terminal, portable computer, Personal Digital Assistant (PDA), pager, thin client, or any other similar type of digital electronic device. The capability of such a terminal to request and/or receive information or data can be provided by software, hardware and/or firmware. A terminal may comprise or be associated with other devices, for example a local data storage device such as a hard disk drive or solid state drive.

An information source can comprise a server, or any type of terminal, that may be associated with one or more storage devices that are able to store information or data, for example in one or more databases residing on a storage device. The exchange of information (ie. the request and/or receipt of information or data) between a terminal and an information source, or other terminal(s), is facilitated by a communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

The reference in this specification to any prior publication (or information derived from the prior publication), or to any matter which is known, is not, and should not be taken as an acknowledgment or admission or any form of suggestion that the prior publication (or information derived from the prior publication) or known matter forms part of the common general knowledge in the field of endeavour to which this specification relates.

### DISCLOSURE OF INVENTION

In one broad form there is provided a method of restricting a client processing system being compromised, wherein the method comprises:

receiving, in a proxy server, response data from a remote processing system, according to a request from the client processing system to download data from the remote processing system;

analysing the response data to determine if at least a portion of the response data is malicious; and

in the event that at least a portion of the response data is malicious, modifying the response data to restrict the client processing system being compromised.

In one form, the method comprises:

determining, using a cache module, if the request has previously been serviced, wherein the cache module stores analysed response data; and

in the event that the request has previously been serviced, retrieving, using the cache module, analysed response data.

In another form, the method comprises:

storing, using the cache module, analysed response data using a hash value generated based upon the response data; and

retrieving, using the cache module, analysed response data using a hash value generated using received response data.

In one embodiment, the method comprises removing a portion of the response data which is associated with malicious activity.

In another embodiment, the method comprises replacing the portion removed from the response data with a non-malicious portion.

In an optional form, upon determining that the response data requires modification, the method comprises:

generating replacement request data indicative of the data requested;

transferring, to the cache module, the replacement request data;

performing a search of stored analysed response data using the cache module to determine if a substantially similar request has previously been serviced; and

receiving, from the cache module, analysed response data which at least substantially corresponds to the requested data.

Additionally or alternatively, the method comprises generating a wrapper of the analysed data, wherein the wrapper is indicative of scan data.

In some embodiments, the wrapper is indicative scan data, the scan data being indicative of at least one of:

version of a signature database used to analyse the response data;

time and/or data of conducting the analysis;

type analysis module and sub-modules used to analyse the response data;

a version number of the analysis module and the sub-modules;

a size of the response data;

a file location; and

an indication as to whether the response data was code-signed.

In one aspect, the step of generating the wrapper comprises configuring the wrapper to intercept use or execution of the data by the client processing system, wherein the wrapper, upon interception of the use or execution of the data, presents the scan data.

In another aspect, the method comprises generating the wrapper to present a prompt requesting input regarding whether the data is to be executed or used by the client processing system, quarantined, or deleted.

In one form, the method comprises:

determining if the data is executable;

in the event that the data is executable, using an emulated operating system to execute the data;

monitoring events that occur in the emulated operating system during execution of the data; and

analysing the events to determine if at least a portion of the response data is malicious.

In another broad form there is provided a system to restrict a client processing system being compromised with malicious software, wherein the system is configured to:
receive, in a proxy server, response data from a remote processing system, according to a request from the client processing system to download data from the remote processing system;
analyse the response data to determine if at least a portion of the response data is malicious; and
in the event that at least a portion of the response data is malicious, modify the response data to restrict the client processing system being compromised.

In one form, the proxy server is configured to be executed at the client processing system.

In another form, the proxy server is configured to be executed at a second processing system in data communication with the client processing system.

In one embodiment, the system comprises an analysis module configured to analyse the response data, wherein the analysis module comprises at least one of: a cryptographic hash module;

a checksum module;

a disassembly module;

a black-list and/or white list module; and

a pattern matching module.

In another embodiment, the system comprises:

cache module configured to:
store analysed response data;
determine if the request has previously been serviced; and
retrieve analysed response data in the event that the request has previously been serviced.

In another form, upon determining that the response data requires modification, the system is configured to:

generate replacement request data indicative of the data requested;

transfer, to the cache module, the replacement request data;

perform a search of stored analysed response data using the cache module to determine if a substantially similar request has previously been serviced; and

receive, from the cache module, analysed response data which at least substantially corresponds to the requested data.

In one aspect, the system is configured to generate a wrapper of the analysed data, wherein the wrapper is indicative of scan data.

In another aspect, the system generates the wrapper to intercept use or execution of the data by the client processing system, wherein the wrapper, upon interception of the use or execution of the data, presents the scan data.

In another form, the system is configured to:

determine if the data is executable;

in the event that the data is executable, use an emulated operating system to execute the data;

monitor events that occur in the emulated operating system during execution of the data; and

analyse the events to determine if at least a portion of the response data is malicious.

In another broad form there is provided a computer program product comprising a computer readable medium having a computer program recorded therein or thereon, the computer program enabling restriction of a client processing system being compromised by data downloaded from a remote processing system, wherein the computer program product configures the client processing system or a second processing system in data communication with the client processing system to:

receive, in a proxy server, response data from the remote processing system, according to a request from the client processing system to download data from the remote processing system;

analyse the response data to determine if at least a portion of the response data is malicious; and

in the event that at least a portion of the response data is malicious, modify the response data to restrict the client processing system being compromised.

According to another broad form, there is provided a computer readable medium of instructions for giving effect to any of the aforementioned methods or systems. In one particular, but non-limiting, form, the computer readable medium of instructions are embodied as a software program.

### BRIEF DESCRIPTION OF FIGURES

An example embodiment of the present invention should become apparent from the following description, which is given by way of example only, of a preferred but non-limiting embodiment, described in connection with the accompanying figures.

FIG. 1 illustrates a functional block diagram of an example processing system that can be utilised to embody or give effect to a particular embodiment;

FIG. 2 illustrates a block diagram representing an example system to restrict malicious software compromising a client processing system;

FIG. 3 illustrates a flow diagram representing an example method of restricting malicious software compromising a client processing system;

FIG. 4 illustrates a block diagram representing a more detailed example system to restrict malicious software compromising a client processing system;

FIGS. 5A and 5B illustrate a flow diagram representing a more detailed example method to restrict malicious software compromising a client processing system; and

FIG. 6 illustrates a block diagram representing an example analysis module.

### MODES FOR CARRYING OUT THE INVENTION

The following modes, given by way of example only, are described in order to provide a more precise understanding of the subject matter of a preferred embodiment or embodiments.

In the figures, incorporated to illustrate features of an example embodiment, like reference numerals are used to identify like parts throughout the figures.

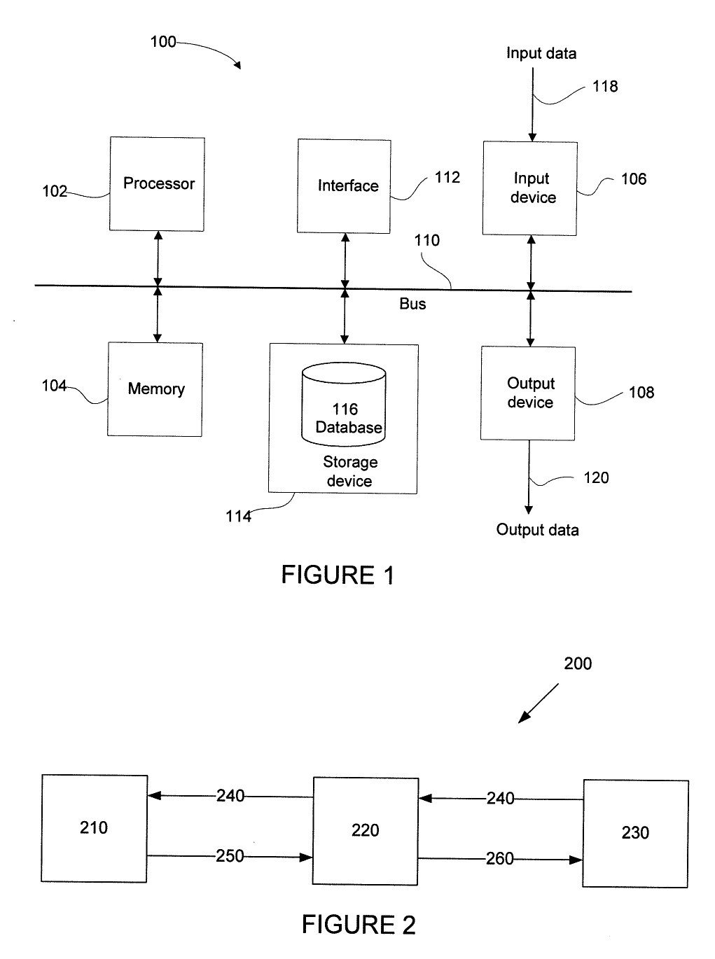

A particular embodiment of the present invention can be realised using a processing system, an example of which is shown in FIG. 1. In particular, the processing system 100 generally comprises at least one processor 102, or processing unit or plurality of processors, memory 104, at least one input device 106 and at least one output device 108, coupled together via a bus or group of buses 110. In certain embodiments, input device 106 and output device 108 could be the same device. An interface 112 can also be provided for coupling the processing system 100 to one or more peripheral devices, for example interface 112 could be a PCI card or PC card. At least one storage device 114 which houses at least one database 116 can also be provided. The memory 104 can be any form of memory device, for example, volatile or non-volatile memory, solid state storage devices, magnetic devices, etc. The processor 102 could comprise more than one distinct processing device, for example to handle different functions within the processing system 100.

Input device 106 receives input data 118 and can comprise, for example, a keyboard, a pointer device such as a pen-like device or a mouse, audio receiving device for voice controlled activation such as a microphone, data receiver or antenna such as a modem or wireless data adaptor, data acquisition card, etc. Input data 118 could come from different sources, for example keyboard instructions in conjunction with data received via a network. Output device 108 produces or generates output data 120 and can comprise, for example, a display device or monitor in which case output data 120 is visual, a printer in which case output data 120 is printed, a port for example a USB port, a peripheral component adaptor, a data transmitter or antenna such as a modem or wireless network adaptor, etc. Output data 120 could be distinct and derived from different output devices, for example a visual display on a monitor in conjunction with data transmitted to a network. A user could view data output, or an interpretation of the data output, on, for example, a monitor or using a printer. The storage device 114 can be any form of data or information storage means, for example, volatile or non-volatile memory, solid state storage devices, magnetic devices, etc.

In use, the processing system 100 is adapted to allow data or information to be stored in and/or retrieved from, via wired or wireless communication means, the at least one database 116. The interface 112 may allow wired and/or wireless communication between the processing unit 102 and peripheral components that may serve a specialised purpose. More than one input device 106 and/or output device 108 can be provided. It should be appreciated that the processing system 100 may be any form of terminal, server, specialised hardware, or the like.

The processing system 100 may be a part of a networked communications system. Processing system 100 could connect to a network, for example the Internet or a WAN. Input data 118 and output data 120 could be received from or communicated to other devices, such as a server, via the network. The network may form part of, or be connected to, the Internet, and may be or form part of other communication networks, such as LAN, WAN, ethernet, token ring, FDDI ring, star, etc., networks, or mobile telephone networks, such as GSM, CDMA or 3G, etc., networks, and may be wholly or partially wired, comprising for example optical fibre, or wireless networks, depending on a particular implementation.

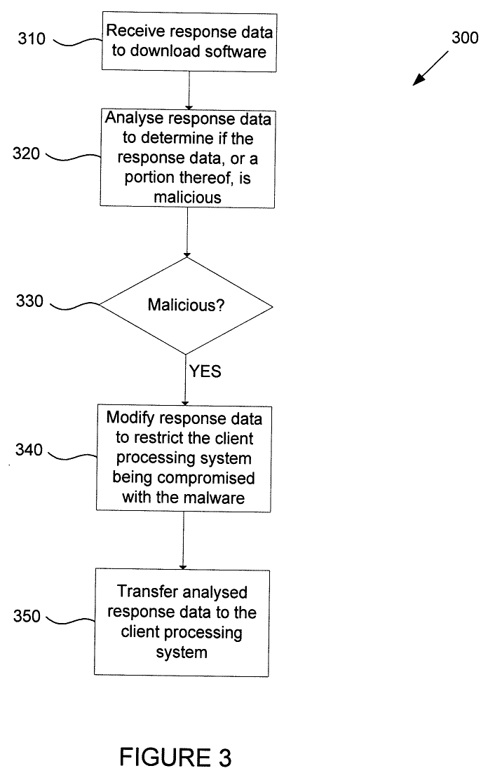

Referring now to FIG. 2 there is shown an example system to restrict a client processing system being compromised with a threat such as malicious software. In particular, the system 200 comprises a remote processing system 210, a proxy server 220, and a client processing system 230 which are in data communication. The proxy server may be a stand alone processing system 100, however, it will be appreciated that the proxy server 220 may be an executable software application at either the remote processing system 210 or the client processing system 230. It will also be appreciated that client processing system 230 and remote processing system 210 may be forms of processing system 100.

When a user at the client processing system 230 attempts to download data such as software from the remote processing system 210, request data 240 is generated by the client processing system 230 and transferred to the proxy server 220. Generally, the proxy server 220 then transfers the request data 240 to the remote processing system 210. In accordance with the request data 240, the remote processing system 210 generates response data 250 which is transferred to the proxy server 220. The proxy server 220 analyses the response data to determine if the response data is malicious. If malicious, at least as a portion of the response data 250 is modified to restrict the client processing system 230 being compromised. Analysed response data 260 is then transferred to the client processing system 230 from the proxy server 220.

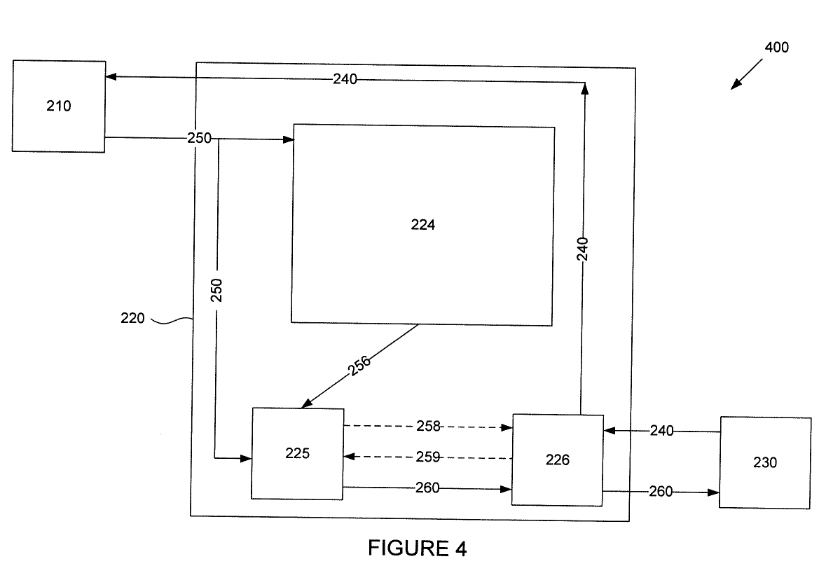

Referring now to FIG. 3, there is shown a flow diagram illustrating an example method of restricting the client processing system 230 being compromised.

In particular, at step 310 the method 300 comprises the proxy server 220 receiving response data 250 to a request 240 to download data from the remote processing system 210. At step 320, the method 300 comprises analysing the response data to determine if the response data is malicious. At step 330, in the event that the response data is malicious, the method 300 proceeds to step 340 which comprises the proxy server 220 modifying the response data 250 so as to restrict the client processing system 230 being compromised with the malicious software of the response data 250. At step 350 the method 300 comprises transferring the analysed response data 260 to the client processing system 230.

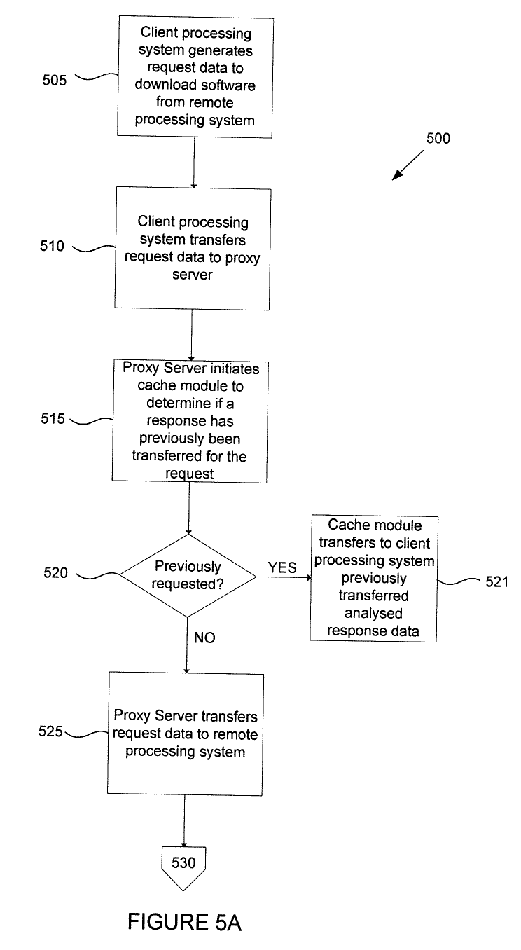

Referring now to FIG. 4, there is shown another example system 400 to restrict a client processing system 230 being compromised with software. Although the following example is in relation to downloading software, it will be appreciated that other forms of data could be downloaded.

In particular, the proxy server 220 comprises an analysis module 224, a modification module 225 and a cache module 226.

When the client processing system 230 transfers request data 240 to the proxy server 220, the cache module 226 analyses the request 240 to determine if the request 240 has previously been serviced. The cache module 226 is configured to store analysed response data 260 that has been previously transferred to the client processing system 230.

In one form, the cache module 226 may store a hash value of each serviced request 240 and the associated analysed response 260. The cache module 226 may be configured to determine a hash value for the received request 240, wherein records of previously serviced requests 240 are searched using the determined hash value to determine if the request 240 has been responded to previously. In the event that the received request data 240 has been previously serviced, the cache module 226 retrieves the relevant analysed response data 260 which is transferred to the client processing system 230.

In the event that the cache module 226 does not comprise a recorded response 260 to the particular request 240, the request data 240 is transferred to the server processing system 210. The operation of the analysis module 224 will be discussed in more detail below.

Results 256 of the analysis performed by the analysis module 224 are then transferred to the modification module 225. The response data 250 is also transferred to the modification module 225. The modification module 225 can modify, if appropriate, the software in accordance with the results 256 of the analysis. For example, the results 256 may indicate that a portion of the software is malicious. Therefore, the modification module 225 may remove the malicious portion of the software from the response data 250. The modification module 225 may optionally replace the malicious portion of the software with a non-malicious portion of software, as will be explained in more detail below. In some instances, the entire downloaded software may be considered malicious and as such may be either removed or replaced with a non-malicious version of the software, as will also be explained in more detail below. If the analysis results 256 indicate that the software is non-malicious, then the software does not require modification.

A wrapper component can be comprised in the analysed response data 260 to indicate scanning data. The scanning data may be indicative of a version of a signature database which was used by the analysis module 224 to analyse the response data 250. The scanning data may be indicative of at least one of: the time and/or date which the scan was performed; the type of scanning modules used by the analysis module 224; a version number indicative of the analysis module 224; a size of the downloaded software; file location; and whether the downloaded software is code-signed.

When the user receives the analysed response data 260 and attempts to execute the downloaded software, the wrapper component may be executed by the client processing system, displaying to the user the scanning data. The wrapper component can provide a prompt to the user requesting confirmation that, based on the scanning data, the user still wishes to execute the software. The user may indicate, using the input device of the client processing system 230, that the software is to be executed or that the software is to be deleted or quarantined for further analysis.

Optionally, the modification module 225 may accept a code-signed prompt, such that the user at the client processing system 230 is not prompted to perform the acceptance.

In the event that the software, or a portion thereof, is to be replaced, the modification module 225 may generate and transfer a replacement request 258 to the cache module 226. The replacement request 258 can indicate the software of the response data 250. For example, information such as a name of the software, the version of the software may be comprised in the replacement request 258, and the network address of the server processing system 210 which transferred the response data 250.

In response to the replacement request 258, the cache module 226 performs a search of recorded analysed response data 260 to determine if a similar request had been previously serviced for the requested software. In the event that the cache module 226 determines a previous non-malicious version of the software had been provided to a client processing system 230 in the past, the cache module 226 may transfer the closest matching software 259, or portion thereof, back to the modification module 225. The modification module 225 may then use the closest matching software 259, or portion thereof, to modify the response data 250 so as to restrict the client processing system 230 being compromised with malicious software. For example, the modification module 225 may remove a particular malicious file from the software and replace it with an earlier non-malicious version of the file which had previously been transferred to the client processing system 230. Alternatively, the entire malicious software may be removed from the response data 250, and the non-malicious version of the software may be comprised.

The analysed response data 260 is then transferred from the modification module 225 to the cache module 226 for caching. Once the cache module 226 has cached the analysed response data 260, the analysed response data 260 is then transferred from the cache module 226 to the client processing system 230.

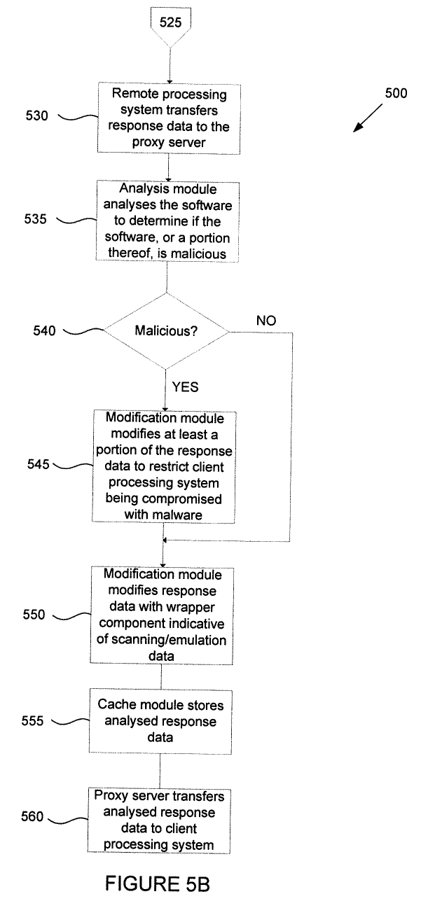

Referring now to FIGS. 5A and 5B there is shown a more detailed flow diagram illustrating a method of restricting the client processing system being compromised with malicious software. Although the following example is in relation to downloading software, it will be appreciated that other forms of data could be downloaded.

In particular, at step 505 the method 500 comprises the client processing system 230 generating request data 240 to download software from the remote processing system 210. This may be performed by the user selecting, using input device 106, a hyperlink in a web-page available on the Internet, wherein the hyperlink allows software to be downloaded from the remote processing system 210. At step 510, the method 500 comprises the client processing system 230 transferring the request data to the proxy server 220.

At step 515, the method 500 comprises the proxy server 220 initiating the cache module 226 to determine whether an analysed response 260 has previously been transferred to a client processing system 230 for the requested software. At step 520, if the software has previously been requested and suitable analysed response data 260 is available in the cache module 226, the method 500 proceeds to step 521 where the cache module 261 transfers to the client processing system 230 previously transferred analysed response data 260. In the event that the cache module 226 does not comprise suitable analysed response data 260 for the software requested, the method 500 proceeds to step 525 where the cache module 226 transfers the request data 240 to the remote processing system 210.

At step 530, the method 500 comprises the remote processing system 210 transferring response data 250 to the proxy server 220, wherein the response data 250 is indicative of the requested software.

At step 535, the method 500 comprises the analysis module 224 analysing the software of the response data 250 to determine if the software is malicious. At step 540, in the event that the software, or a portion thereof, is determined to be malicious, the method proceeds to step 545. In the event that the software was non-malicious, the method proceeds to step 550.

At step 545, the method 500 comprises the modification module 225 modifying at least a portion of the response data 250 to restrict the client processing system 230 being compromised with malicious software. This step can comprise removing the software from the response data 250 and modifying the response data to indicate that the software was malicious. In another form, a malicious portion of the software can be removed. In another form, the software, or a portion thereof, can be replaced with non-malicious software, or portion thereof, retrieved from the cache module 226 as has previously been discussed.

At step 550, the wrapper component is added to the analysed response data 260, wherein the wrapper component is indicative of scan data. In other optional forms, any code-signing provided with the response data can be accepted.

At step 555, the method 500 comprises the cache module 226 storing the analysed response data 260. The cache module 226 records in a store, such as a database, the analysed response data 260 in association with the request data 240. The cache module 261 may calculate a hash value for the analysed response data 260 and/or the request data 240 and store this in the database such that the cache 226 can be easily searched. Other information may also be stored in the cache module 226 such as the date and/or time which the software was requested such that unsuitable recordings in the cache module 226 can be removed when appropriate.

At step 560, the cache module 226 transfers the analysed response data 260 to the client processing system 230. The analysed response data 260 may comprise the requested software. However, if the software transferred from the remote processing system 210 was determined to be malicious, then it may be possible that the software, or a portion thereof, may have been removed. It is also possible that a replacement version of the software may be comprised in the analysed response data 260, wherein the different version of the software, or portion thereof, is considered to not be malicious. In another form, the analysed response data 260 may comprise modified software, wherein one of the software's components may have been modified or replaced.

The analysed response data 260 may indicate to the user what modification, if any occurred by the proxy server 220, and the reasons for any modification.

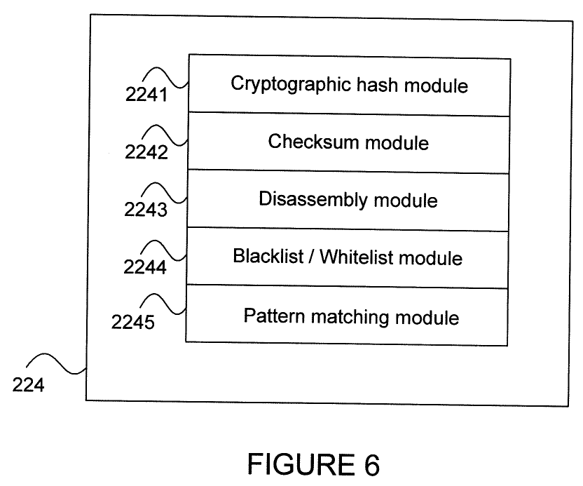

Referring now to FIG. 6 there is shown a block diagram of the analysis module 224.

In particular, the analysis module 224 can comprise the modules of the malicious a cryptographic hash module 2241, a checksum module 2242, a disassembly module 2242, a black-list/white-list module 2244, and a pattern matching module 2245.

The cryptographic hash module 2241 of the analysis module 224 is configured to generate a cryptographic hash value of at least a portion of the software. As the cryptographic hash value can be used as an identity, the cryptographic hash value can be used in comparisons with the blacklist/whitelist module 2244 to determine whether the at least a portion of the software is malicious.

The checksum module 2242 of the analysis module 224 is configured to determine a checksum of the software. The checksum can be compared to a database (blacklist/whitelist module 2244) to determine whether the software is malicious.

The pattern matching module 2245 of the analysis module 224 is configured to search the software for particular patterns of strings, instructions, or events which are indicative of malicious activity. The pattern matching module 2245 may operate in combination with the disassembly module 2243 of the analysis module 224.

The disassembly module 2243 is configured to disassemble binary code of the software such that the disassembly module 2243 determines processing system instructions. The processing system instructions of the software can then be used by the pattern matching module 2245 to determine whether the software is malicious. Although strings of instructions can be compared by the pattern matching module 2245, the pattern matching module 2245 may be configured to perform functional comparisons of groups of instructions to determine whether the functionality of software is indicative of malicious software.

The blacklist/whitelist module 2244 of the analysis module 224 comprises a list of malicious and/or non-malicious software. The blacklist/whitelist module 2244 may be provided in the form of a table or database which comprises data indicative of malicious and non-malicious software. The table may comprise checksums and cryptographic hash values for malicious and non-malicious software. The data stored in the blacklist/whitelist module 2244 can be used to determine whether the software is malicious or non-malicious.

In one form, statistical processes, fuzzy logic processes and/or heuristical processes can be used in combination with the related entity rules, the starting entity rules, and/or the malicious assessment rules to determine whether a rule has been satisfied by an entity of the software.

The embodiments illustrated may be implemented as a software package or component. Such software can then be used to pro-actively seek to determine one or more malicious entities. Various embodiments can be implemented for use with the Microsoft Windows operating system or any other modern operating system. The embodiments described throughout can also be implemented via hardware, or a combination of hardware and software.

The embodiments described can be used to detect and remove malicious software from a network request, such as a HTTP request or FTP download. While the current implementation is Linux (eg: Squid with ICAP enabled, WINE, QEMU) and Windows specific, the disclosed methods and systems may be applied to modern operating systems on any device comprising embedded gateway appliances such as routers and firewalls.

The cache module 226 may apply one or more algorithms to remove unsuitable cached analysed response data 260. Such algorithms may comprise Least Recently Used (LRU) and Least Frequently Used (LFU).

In one form, the proxy server can be configured to determine if the data which has been downloaded is executable. If in the event that the data is executable, the proxy server uses an emulated operating system to execute the data. Events that occur are then monitored in the emulated operating system during execution of the data. The events monitored may be specific events associated with malicious behaviour or all particular events that occur in the emulated operating system are monitored. The events may be recorded in memory such as a data log file or database. The events may be monitored using interception techniques previously discussed, wherein a hook function may be used to monitor events that occur in the processing system executing the data. The events are then analysed to determine if at least a portion of the response data is malicious. The proxy server may use the analysis module to analyse the recorded events. In the event that at least a portion of the response data is malicious, the response data is modified accordingly. A detailed explanation of monitoring behaviour of malicious software is described in the Applicant's following co-pending applications, the content of which is herein by incorporated by cross-reference: co-pending U.S. patent application Ser. No. 11/829,592 and co-pending Australian Patent application AU2007203543 entitled “Threat Identification”; co-pending U.S. patent application Ser. No. 11/829,608 and co-pending Australian Patent application AU2007203534 entitled “Real Time Malicious Software Detection”; and co-pending U.S. patent application Ser. No. 11/780,113 and co-pending Australian Patent application AU2007203373 entitled “Detecting Malicious Activity”.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

An example piece of pseudocode for implementing a method of restricting malicious software compromising the client processing system is provided below:

010 Procedure Eventhandler OnClientRequestFile(client, fileLocation)
020 Begin
030 localFile = createTempFileName( );
040 Call download_file(fileLocation, localFile);
050 Resp = scan_file(localFile);
060 If Resp.Result == FILE_CLEAN Then Begin
070 If setting == DONT_MODIFY Then Begin
080 Call Send_File(client, localFile);
090 End Else Begin
100 Type = determine_filetype(localFile);
110 Env_Info = GetEnvironmentInfo( );
120 Call modify_file(Type, localFile, Env_Info, Resp, bCodeSign);
130 Call Send_File(client, localFile);
140 End;
150 End;
160 If Resp.Result == FILE_MALICIOUS_SOFTWARE Then Begin
170 If setting == DONT_MODIFY Then Begin
180 Call redirect(client, info_location);
190 End Else Begin
200 Type = determine_filetype(localFile);
210 Env_Info = GetEnvironmentInfo( );
220 localInfoFile = get_localInfoFile_Name(type);
230 tempFile = createTempFileName( );
240 Call file_copy(localInfoFile, tempFile);
250 Call modify_file(Type, tempFile, Env_Info, Resp, bCodeSign);
260 Call Send_File(client, tempFile);
270 End;
280 End;
290 End;

The claims defining the invention are as follows:

1. A method of restricting a client processing system being compromised, wherein the method comprises:
receiving, in a proxy server, response data from a remote processing system, according to a request from the client processing system to download data from the remote processing system;
analysing the response data to determine if at least a portion of the response data is malicious; and
in the event that at least a portion of the response data is malicious, modifying the response data to restrict the client processing system being compromised.

2. The method according to claim 1, wherein the method comprises:
determining, using a cache module, if the request has previously been serviced, wherein the cache module stores analysed response data; and
in the event that the request has previously been serviced, retrieving, using the cache module, analysed response data.

3. The method according to claim 2, wherein the method comprises:
storing, using the cache module, analysed response data using a hash value generated based upon the response data; and
retrieving, using the cache module, analysed response data using a hash value generated using received response data.

4. The method according to claim 1, wherein the method comprises removing a portion of the response data which is associated with malicious activity.

5. The method according to claim 4, wherein the method comprises replacing the portion removed from the response data with a non-malicious portion.

6. The method according to claim 4, wherein upon determining that the response data requires modification, the method comprises:
generating replacement request data indicative of the data requested;
transferring, to the cache module, the replacement request data;
performing a search of stored analysed response data using the cache module to determine if a substantially similar request has previously been serviced; and
receiving, from the cache module, analysed response data which at least substantially corresponds to the requested data.

7. The method according to claim 1, wherein the method comprises generating a wrapper of the analysed data, wherein the wrapper is indicative of scan data.

8. The method according to claim 7, wherein the wrapper is indicative scan data, the scan data being indicative of at least one of:
a version of a signature database used to analyse the response data;
time and/or data of conducting the analysis;
type analysis module and sub-modules used to analyse the response data;
a version number of the analysis module and the sub-modules;
a size of the response data;
a file location; and
an indication as to whether the response data was code-signed.

9. The method according to claim 8, wherein the step of generating the wrapper comprises configuring the wrapper to intercept use or execution of the data by the client processing system, wherein the wrapper, upon interception of the use or execution of the data, presents the scan data.

10. The method according to claim 9, wherein the method comprises generating the wrapper to present a prompt requesting input regarding whether the data is to be executed or used by the client processing system, quarantined, or deleted.

11. The method according to claim 1, wherein the method comprises:
determining if the data is executable;
in the event that the data is executable, using an emulated operating system to execute the data;
monitoring events that occur in the emulated operating system during execution of the data; and
analysing the events to determine if at least a portion of the response data is malicious.

12. A system to restrict a client processing system being compromised with malicious software, wherein the system is configured to:
receive, in a proxy server, response data from a remote processing system, according to a request from the client processing system to download data from the remote processing system;
analyse the response data to determine if at least a portion of the response data is malicious; and
in the event that at least a portion of the response data is malicious, modify the response data to restrict the client processing system being compromised.

13. The system according to claim 12, wherein the proxy server is configured to be executed at the client processing system.

14. The system according to claim 12, wherein the proxy server is configured to be executed at a second processing system in data communication with the client processing system.

15. The system according to claim 12, wherein the system comprises an analysis module configured to analyse the response data, wherein the analysis module comprises at least one of:
a cryptographic hash module;
a checksum module;
a disassembly module;
a black-list and/or white list module; and
a pattern matching module.

16. The system according to claim 12, wherein the system comprises:
a cache module configured to:
store analysed response data;
determine if the request has previously been serviced; and
retrieve analysed response data in the event that the request has previously been serviced.

17. The system according to claim 16, wherein upon determining that the response data requires modification, the system is configured to:
generate replacement request data indicative of the data requested;
transfer, to the cache module, the replacement request data;
perform a search of stored analysed response data using the cache module to determine if a substantially similar request has previously been serviced; and
receive, from the cache module, analysed response data which at least substantially corresponds to the requested data.

18. The system according to claim 12, wherein the system is configured to generate a wrapper of the analysed data, wherein the wrapper is indicative of scan data.

19. The system according to claim 18, wherein the system generates the wrapper to intercept use or execution of the data by the client processing system, wherein the wrapper, upon interception of the use or execution of the data, presents the scan data.

20. The system according to claim 12, wherein the system is configured to:
determine if the data is executable;
in the event that the data is executable, use an emulated operating system to execute the data;
monitor events that occur in the emulated operating system during execution of the data; and
analyse the events to determine if at least a portion of the response data is malicious.

21. A computer program product comprising a computer readable medium having a computer program recorded therein or thereon, the computer program enabling restriction of a client processing system being compromised by data downloaded from a remote processing system, wherein the computer program product configures the client processing system or a second processing system in data communication with the client processing system to:
receive, in a proxy server, response data from the remote processing system, according to a request from the client processing system to download data from the remote processing system;
analyse the response data to determine if at least a portion of the response data is malicious; and
in the event that at least a portion of the response data is malicious, modify the response data to restrict the client processing system being compromised.
